(19) United States
(12) Patent Application Publication
(10) Pub. No.: US 2014/0257773 A1
(43) Pub. Date: Sep. 11, 2014

(54) METHOD OF PREDICTING TOXICITY OF CHEMICALS WITH RESPECT TO MICROORGANISMS AND METHOD OF EVALUATING BIOSYNTHETIC PATHWAYS BY USING THEIR PREDICTED TOXICITIES

(71) Applicant: Samsung Electronics Co., Ltd., Suwon-si (KR)

(72) Inventors: So-young LEE, Daejeon (KR); So-jeong YUN, Suwon-si (KR); Tae-yong KIM, Daejeon (KR); Jae-chan PARK, Yongin-si (KR); Jin-woo PARK, Daejeon (KR); Kyu-sang LEE, Ulsan (KR)

(73) Assignee: Samsung Electronics Co., Ltd., Suwon-si (KR)

(21) Appl. No.: 14/200,438

(22) Filed: Mar. 7, 2014

(30) Foreign Application Priority Data
Mar. 8, 2013 (KR) 10-2013-0025247

(51) Int. Cl. G06F 17/50

(52) U.S. Cl. CPC G06F 17/5009
USPC 703/2

(57) ABSTRACT

Provided is a method of generating a toxicity prediction model for a microorganism, a method of predicting the toxicity of a chemical substance to a microorganism using the toxicity prediction model, and a method of assigning priorities to biosynthetic pathways for a target material using the toxicity prediction method.

### CROSS-REFERENCE TO RELATED APPLICATIONS

This application claims the benefit of Korean Patent Application No. 10-2013-0025247, filed on Mar. 8, 2013, in the Korean Intellectual Property Office, the entire disclosure of which is incorporated herein by reference.

### BACKGROUND

1. Field

The present disclosure relates to a method of predicting the toxicity of chemicals to a microorganism and a method of evaluating pathways by using their predicted toxicity.

2. Description of the Related Art

Metabolic engineering refers to the genetic manipulation of metabolic properties of cells or cell strains by adding a new metabolic pathway or removing, amplifying or modifying an existing metabolic pathway. Using metabolic engineering, components of a living organism may be modified to create an efficient system or a new biological system suitable for an intended goal.

Toxicity is an important factor to consider in developing a metabolic pathway for the biosynthesis of metabolic products at high concentrations. A quantitative structure-activity relationship (QSAR) method is a technology that predicts a value from a quantitative correlation of the chemical structure, physicochemical properties, and toxicity of a chemical substance on the assumption that chemical substances with similar structures have similar properties. In particular, QSAR is of importance in pre-screening properties or toxicity of chemical substances under new development.

### SUMMARY

Provided is a computer-implemented method of generating a toxicity prediction model for a microorganism, a method of predicting toxicity of a chemical substance to a microorganism using the generated toxicity prediction model, and a method of assigning priorities to biosynthetic pathways for a target material using the toxicity prediction method.

Additional aspects will be set forth in part in the description which follows and, in part, will be apparent from the description, or may be learned by practice of the presented embodiments.

According to an aspect of the present invention, there is provided a computer-implemented method of generating a toxicity prediction model, the method including: receiving information on toxicity to a microorganism, structural properties and physicochemical properties of chemical substances; calculating molecular descriptors based on the information on structural properties and physicochemical properties; selecting molecular descriptors based on the calculated molecular descriptors and the information on toxicity; and generating a toxicity prediction model using the selected molecular descriptors to predict the toxicity of a chemical substance to the microorganism.

In an exemplary embodiment of the present invention, the method may include receiving information on the toxicity to a microorganism, structural properties and physicochemical properties of chemical substances, from a database or a device that provides experimental data. The microorganism may be a prokaryote or a eukaryote. The prokaryote may be Esherichia coli. The eukaryote may be an yeast. The database may be a PubChem, ChemBank, DrugBank, KEGG, BRENDA, or BioCYC database. The information on toxicity may be quantitatively and/or qualitatively indicated. The quantitative information on toxicity may be an IC₅₀ value. IC₅₀ refers to a concentration of a chemical substance which inhibits the growth of a microorganism by 50%. The quantitative information on toxicity may be indicated as “toxic” or “safe.” The information on structural properties may include, for example, an inter-atomic distance between molecules of a compound, an angle between adjacent atoms, a degree of warping of molecules, molecule oscillation, and/or orbital. The information on physicochemical properties may include, for example, density, a melting point, a boiling point, a molecular weight, solubility, and/or vapor pressure.

The method may include calculating molecular descriptors from the received information on structural properties and physicochemical properties. A molecular descriptor refers to a numerical value corresponding to the structure or physicochemical properties of a molecule. The calculation may be executed using a software program for calculating molecular descriptors. The molecular descriptors may include at least one selected from the group consisting of a constitutional descriptor, a physicochemical descriptor, a geometric descriptor, and an electrostatic descriptor. The molecular descriptors may further include a topological descriptor. In an exemplary embodiment of the present invention, the molecular descriptors may include a constitutional descriptor, a physicochemical descriptor, a geometric descriptor, an electrostatic descriptor, and a topological descriptor.

The constitutional descriptor may include, for example, a rotatable bonds count, a molecular weight, a longest aliphatic chain, a Lipinski rule of five, a largest Pi system, a largest chain, an atom count, a bond count, an aromatic bond count, hydrogen bond acceptors, a hydrogen bond donator, an aromatic atom count, and/or atomic polarizations. The physicochemical descriptors may be numerical values which represent physico-chemical properties of substances. The physicohemical descriptor may include parameters to account for hydrophobicity, topology, electronic properties, and steric effects. The physicochemical descriptor may include, for example, X log P. The geometric descriptor may include, for example, a gravitational index, a length over breadth, a moment of inertia, and/or a Petitjean shape index. The electrostatic descriptor may include, for example, an ionizational potential, a charged partial surface area, and/or bond polarizabilities (BPol). The topological descriptor may include, for example, carbon connectivity index (order 0) (Carbon Connec Order Zero), carbon connectivity index (order 1) (Carbon Connec Order One), chi chain indices, chi cluster indices, chi path indices, chi path cluster indices, eccentric connectivity index, kappa shape indices, molecular distance edge (MDE), autocorrelation polarizability, autocorrelation charge, autocorrelation mass, petitjean number, topological polar surface area (TPSA), vertex adj magnitude, weighted path, weinner number, zagreb index, weighted holistic invariant molecular(WHIM), BOUT, atomic valence connectivity index order 0, atomic valence connectivity index order 1, and/or fragment complexity.

In an exemplary embodiment of the present invention, the method may include selecting molecular descriptors based on the calculated molecular descriptors and the information on toxicity. The selection of molecular descriptors may be executed using a statistical analysis method generally used in feature selection. Feature selection refers to a process of selecting a subset of data that can improve the accuracy of classification from the original data. Feature selection may involve the extraction of features most closely related to the purpose of the classification and removing data such as redundant data and noise data which contribute less to the classification, thereby enabling a faster calculation time and more accurate classification. The statistical analysis may include, for example, principal component analysis (PCA), forward selection, backward elimination, stepwise selection, partial least-squares, and/or genetic algorithm. For example, in the case of the principal component analysis, the selection of molecular descriptors may be selection of molecular descriptors in which a cumulative proportion of importance is equal to or greater than a standard value. The proportion of importance refers to a value which represents how well a certain principle component explains information included in original variables. The sum of the proportions regarding each principle component is represented as a cumulative proportion of importance. The standard value may be selected within the range of about 50 to about 100%.

The method may include generating a toxicity prediction model using the selected molecular descriptors to predict the toxicity of a chemical substance to the microorganism. The generation of a toxicity prediction model may be performed using a statistical modeling method or a pattern recognition method using artificial intelligence. The statistical modeling method or the pattern recognition method using artificial intelligence may include a statistical method such as regression analysis, or a pattern classifying method using artificial intelligence such as support vector machine (SVM) or neural network. SVM is supervised learning models with associated learning algorithms that analyze data and recognize patterns, used for classification and regression analysis. The basic SVM takes a set of input data and predicts, for each given input, which of two possible classes forms the output, making it a non-probabilistic binary linear classifier. Given a set of training examples, each marked as belonging to one of two categories, an SVM training algorithm builds a model that assigns new examples into one category or the other. An SVM model is a representation of the examples as points in space, mapped so that the examples of the separate categories are divided by a clear gap that is as wide as possible. New examples are then mapped into that same space and predicted to belong to a category based on which side of the gap they fall on (Cortes, Corinna et al., Support-Vector Networks, Machine Learning, 20, 1995). The modeling method may include, for example, multiple linear regression, random forest regression algorithm, artificial neural network algorithm, SVM algorithm, genetic algorithm, and/or partial least-squares.

In an exemplary embodiment of the present invention, the method may be executed by a processor. The processor may be part of a computing apparatus. FIG. 2 illustrates the apparatus 10 for generating a toxicity prediction model, according to an embodiment of the present invention. Referring to FIG. 2, a receiving unit (receivor) 110, a calculating unit (calculator) 120, a selecting unit (selector) 130, and a generating unit (generator) 140 may be included in the processor 100. The receiving unit 110 may acquire information on the toxicity to a microorganism, structural properties, and physicochemical properties of one or more chemical substances, from a database or a device that provides experimental data. The calculating unit 120 may calculate molecular descriptors based on the received information on structural and physicochemical properties, using descriptor-calculating programs. The selecting unit 130 may select molecular descriptors useful for predicting a toxicity of a chemical substance with respect to the microorganism, based on the calculated descriptors and the received information on toxicity, using statistical analysis. The generating unit 140 may generate a toxicity prediction model with respect to the microorganism based on the selected descriptors, using modeling techniques.

According to another aspect of the present invention, there is provided a method of predicting toxicity of a chemical substance to a microorganism, including: selecting a chemical substance; applying the selected chemical substance to the toxicity prediction model; and predicting the toxicity of the chemical substance to the microorganism based on the the toxicity prediction model.

In an exemplary embodiment of the present invention, the method may include selecting a chemical substance, wherein the toxicity of the substance to the microorganism is to be predicted.

In an exemplary embodiment of the present invention, the method may include applying the selected chemical substance to a toxicity prediction model. In an exemplary embodiment of the present invention, the toxicity prediction model may be a model generated by, for example, receiving information on toxicity to a microorganism, structural properties and physicochemical properties of chemical substances; calculating molecular descriptors based on the information on structural properties and physicochemical properties; selecting molecular descriptors based on the calculated molecular descriptors and the information on toxicity; and generating a toxicity prediction model using selected molecular descriptors. The details of each step are the same as described above.

In an exemplary embodiment of the present invention, the method may include predicting toxicity of the chemical substance to the microorganism based on the toxicity prediction model. The information on toxicity may include quantitative and/or qualitative information. The quantitative information on toxicity may be IC₅₀ values. The qualitative information on toxicity may be indicated as “toxic” or “safe.”

According to another aspect of the present invention, there is provided a method of assigning priorities to biosynthetic pathways for a target material, comprising: receiving information for a plurality of biosynthetic pathways for a target material; obtaining information on toxicity of intermediate metabolites in each biosynthetic pathway by applying the intermediate metabolites to a toxicity prediction model, and evaluating toxicity of each biosynthetic pathway; and assigning priorities to the biosynthetic pathways according to a result of the toxicity evaluation.

In an exemplary embodiment of the present invention, the method may include obtaining a candidate biosynthetic pathway for a target material. The candidate biosynthetic pathway may be, for example, obtained by using a set of reaction rules. The set of reaction rules refers to a group of reaction rules which can explain one or more enzyme-substrate reactions. For example, if 100 reactions can be explained using 10 reaction rules, the 10 reaction rules may constitute a set of reaction rules regarding the 100 reactions.

In an exemplary embodiment of the present invention, the method may include obtaining information on toxicity of intermediate metabolites in each biosynthetic pathway by applying the intermediate metabolites in each biosynthetic pathway to a toxicity prediction model, and evaluating toxicity of each biosynthetic pathway. The toxicity prediction model may be a model generated by, for example, a method of building a toxicity prediction model, including: receiving information on toxicity to a microorganism, structural properties and physicochemical properties of chemical substances; calculating molecular descriptors based on the information on structural properties and physicochemical properties; selecting descriptors based on the calculated molecular descriptors and the information on toxicity; and generating a toxicity prediction model using selected molecular descriptors. The details of each step are the same as described above.

The toxicity values for intermediate metabolites in the biosynthetic pathway may be indicated in terms of IC₅₀. The evaluation of toxicity regarding the biosynthetic pathway may involve determining the lowest IC₅₀ value or the average IC₅₀ value for the pathway. The lowest IC₅₀ indicates the lowest value among the predicted IC₅₀ values for each of the intermediate metabolites in the biosynthetic pathway. The average IC₅₀ indicates the value obtained by averaging the predicted IC₅₀ values for each of the intermediate metabolites in the biosynthetic pathway.

In an exemplary embodiment of the present invention, the method may include assigning priorities to the biosynthetic pathways according to the result of the toxicity evaluation. The priority assignment may involve comparing the lowest or average IC₅₀ values for each pathway. For example, two candidate pathways may be considered for the biosynthesis of a target material in a microorganism. When the lowest IC₅₀ value or the average IC₅₀ value for the first pathway is higher than that for the second pathway, the toxic effects on the microorganism by the first pathway may be regarded to be lower than that by the second pathway. Thus, the first pathway may be given the priority over the second pathway. The pathway which is given the priority over other pathways may be experimentally performed to biosynthesize the target material, due to lower toxic effects on the microorganism.

In assigning priorities in the biosynthetic pathways, the result of toxicity evaluation may be considered along with the reaction properties and chemical properties. The reaction properties may include, for example, thermodynamic feasibility, pathway distance and maximum theoretical yield of product. The chemical properties may include, for example, binding site covalence and chemical similarity.

The methods of the present disclosure may be used, for example, to predict the toxicity of an intermediate metabolite or to re-design the biosynthetic pathway.

### BRIEF DESCRIPTION OF THE DRAWINGS

These and/or other aspects will become apparent and more readily appreciated from the following description of the embodiments, taken in conjunction with the accompanying drawings of which:

FIG. 1 is a diagram illustrating generating of a toxicity prediction model according to an embodiment of the present invention, and a method of predicting toxicity using the same;

FIG. 2 is block diagram of the apparatus 10 for generating a toxicity prediction model, according to an embodiment of the present invention;

FIG. 3 is a diagram illustrating a method of improving a success rate of biosynthesis by using a predicted toxicity in the course of creation, evaluation, and final selection of a new biosynthetic pathway;

FIG. 4 is a graph illustrating the difference in the explanation power of data for molecular descriptors selected in the conventional method and those selected in a method according to an embodiment of the present invention;

FIG. 5 is a diagram showing the predicted toxicity of chemical substances in the biodegradation pathway of xenobiotic compounds via a toxicity prediction model, according to an embodiment of the present invention, and

FIG. 6 is a diagram showing the predicted toxicity of chemical substances in a new biosynthetic pathway of 1,4-BDO via a toxicity prediction model, according to an embodiment of the present invention.

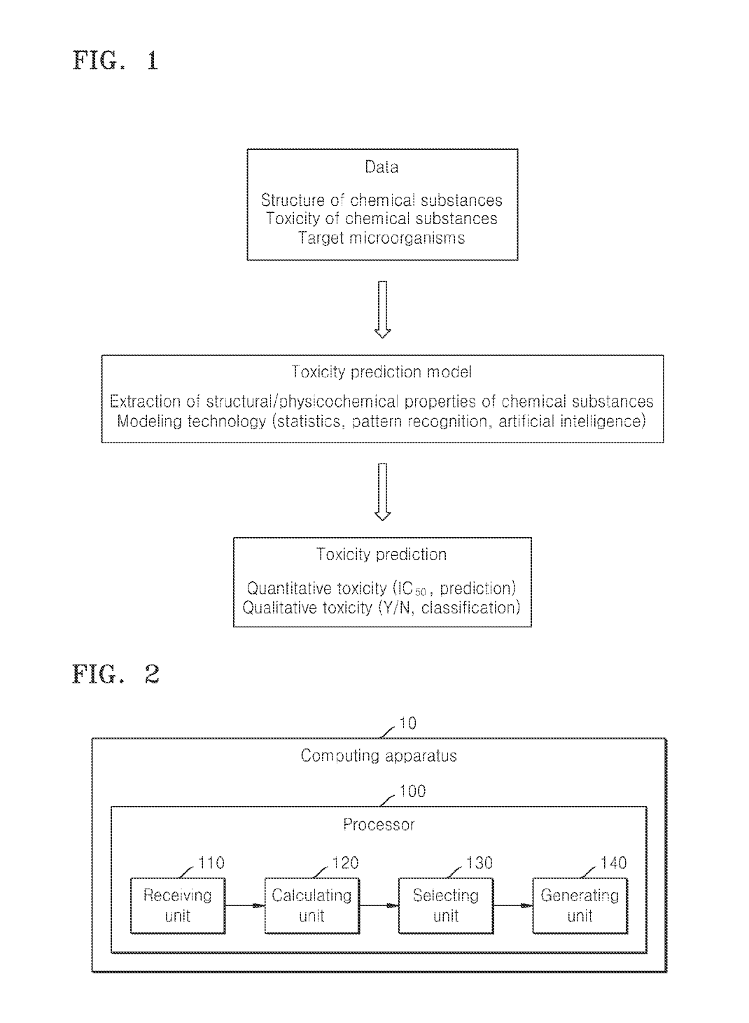

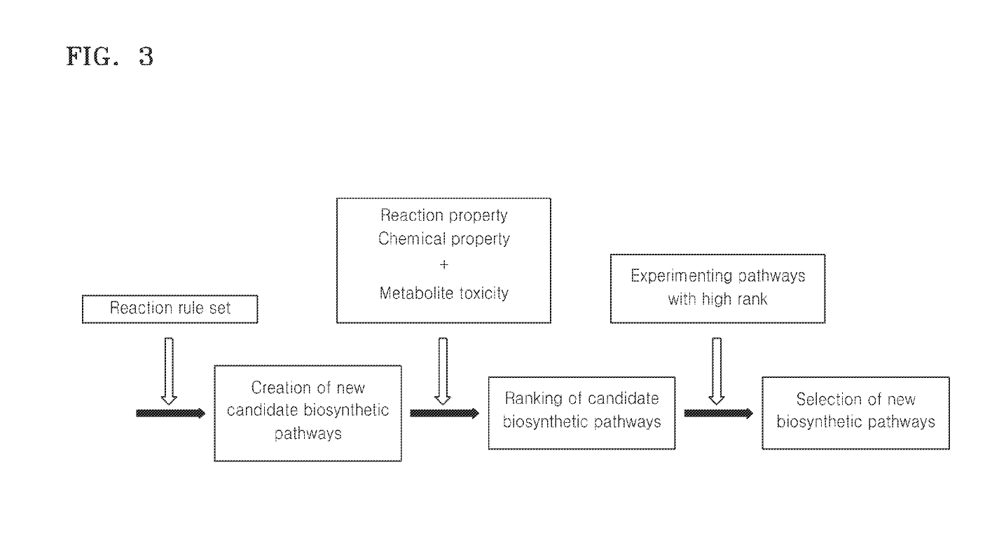

### DETAILED DESCRIPTION

The present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

### EXAMPLE 1

### Generating a Toxicity Prediction Model and Evaluation of its Accuracy

In order to generate a toxicity prediction model for E. coli, information on 73 chemical substances with known IC₅₀, as listed below, were obtained from a PubChem database. Molecular descriptors for each of the chemical substances were calculated via a chemistry development kit program using the thus obtained information (J Chem Inf Comput Sci., Steinbeck C et al., The Chemistry Development Kit (CDK): an open-source Java library for Chemo- and Bioinformatics. 2003, 43(2):493-500). A total of 178 calculated values were obtained for the 44 molecular descriptors set as the basic values in the program. If a calculated value could not be obtained for any one of the chemical substances among them, the value was eliminated. In WHIM descriptors, a total of 6 values (Wgamma1.unity, Wgamma2.unity, Wgamma3.unity, WG.unity, WD.unity, Wetal.unity) were eliminated, such that a total of 172 values were selected. The selected molecular descriptors included a constitutional descriptor, a physicochemical descriptor, a geometric descriptor, an electrostatic descriptor and a topological descriptor, and thus they could exhibit not only properties based on a partial structure but also overall properties. The molecular descriptors used in a method according to an embodiment of the present invention and their calculated values are shown in Table 1 below.

73 Chemical substances used in generating a toxicity prediction model Baclofen, 2-Amino-3-methyl-1-butanol, Bornylamine, Tetrahydro-2-furoic acid, Acetylmandelic acid, 1-(4-fluorophenyl)-2-methyl-2-propylamine, 1-Phenyl-2-propyn-1-ol, 2-Bromodecanoic acid, 3-Hydroxypropionic acid, 4-(1-Pyrrolidinyl)piperidine, 4-Acetylbutyric acid, 4-Hydroxyphenylacetic acid, 4-Methylhexanoic acid, 5-Aminolevulinic acid, 5-Methoxygramine, 5-Methyl benzimidazole, 6-Bromo-1-hexanol, 7-Amino-1,3-naphthalene disulfonic acid, Ampicillin, Azithromycin, β-Alanine, Butylamine, Capreomycin, CAPSO, Cefotaxime, Cephalexin, Chloramphenicol, Congocidine, Cycloserine, Alanine, Arginine, Galacturonic acid, Glucosamic acid, Leucine, Penicillamine, Valine, 2-Aminobutyric acid, Isoleucine, Metheonine, Threo-β-hydroxyaspartic acid, Erythromycin, Fusidic acid, G418, Gentamycin, Glycine, Hygromycin B, Isoprenaline, Isovaleric acid, Kanamycin, Propargylglycine, Canavanine, Mimosine, Serine, Malic acid, Memantine, N-acetyl-alanine, N-acetyl-methionine, N-acetyl-glycine, N-methyloctylamine, Neomycin, Nicotinic acid, O-Acetyl-serine, Oleandomycin, Oxamic acid, Penicillin G, Piperacillin, Propionic acid, Pyruvic acid, Spectinomycin, Sulfacetamide, Syringaldehyde, Vanillin, and Zeocin.

TABLE 1

| | Molecular | | |
|---|---|---|---|
| Classification | Descriptor | Definition; Reference | Calculated Value |
| Constitutional | Rotatable Bonds | Descriptor that calculates the | nRotB |
| descriptor | Count | number of nonrotatable bonds | |
| | | on a molecule | |
| | Molecular Weight | Descriptor based on the weight | MW |
| | | of atoms of a certain element | |
| | | type. If no element is specified, | |
| | | the returned value is the | |
| | | Molecular Weight | |
| | Longest Aliphatic | Returns the number of atoms | nAtom LAC |
| | Chain | in the longest aliphatic chain | |
| | Lipinski Rule of | This Class contains a method | LipinskiFailures |
| | Five | that returns the number failures | |
| | | of the Lipinski's Rule Of Five. | |
| | Largest Pi | Returns the number of atoms | nAtomP |
| | System | in the largest pi chain | |
| | Largest Chain | Returns the number of atoms | nAtomLC |
| | | in the largest chain | |
| | Atom Count | Descriptor based on the | nAtom |
| | | number of atoms of a certain | |
| | | element type | |
| | Bond Count | Descriptor based on the | nB |
| | | number of bonds of a certain | |
| | | bond order | |
| | Aromatic Bond | Descriptor based on the | nAromBond |
| | Count | number of aromatic bonds of a | |
| | | molecule | |
| | Hydrogen Bond | Descriptor that calculates the | nHBAcc |
| | Acceptors | number of hydrogen bond | |
| | | acceptors | |
| | Hydrogen Bond | Descriptor that calculates the | nHBDon |
| | Donator | number of hydrogen bond | |
| | | donors | |
| | Aromatic Atom | Descriptor based on the | naAromAtom |
| | Count | number of aromatic atoms of a | |
| | | molecule | |
| | Atomic | Descriptor that calculates the | apol |
| | Polarizations | sum of the atomic | |
| | | polarizabilities (including | |
| | | implicit hydrogens) | |
| Physicochemical | XlogP | Prediction of logP based on the | XlogP |
| descriptor | | atom-type method called | |
| | | XlogP; | |
| | | Wang, R., Fu, Y., and Lai, L., A | |
| | | New Atom-Additive Method for | |
| | | Calculating Partition | |
| | | Coefficients, Journal of | |
| | | Chemical Information and | |
| | | Computer Sciences, 1997, | |
| | | 37: 615-621; | |
| | | Wang, R., Gao, Y., and Lai, L., | |
| | | Calculating partition coefficient | |
| | | by atom-additive method, | |
| | | Perspectives in Drug Discovery | |
| | | and Design, 2000, 19: 47-66 | |
| Geometric | Gravitational | Descriptor characterizing the | GRAV-1, GRAV- |
| descriptor | Index | mass distribution of the | 2, GRAV-3, |
| | | molecule; | GRAVH-1, |
| | | Katritzky, A. R. and Mu, L. and | GRAVH-2, |
| | | Lobanov, V. S. and Karelson | GRAVH-3, |
| | | M., Correlation of Boiling | GRAV-4, GRAV- |
| | | Points With Molecular | 5, GRAV-6 |
| | | Structure. 1. A Training Set of | |
| | | 298 Diverse Organics and a | |
| | | Test Set of 9 Simple | |
| | | Inorganics, J. Phys. Chem., | |
| | | 1996, 100: 10400-10407; | |
| | | Wessel, M. D. and Jurs, P. C. | |
| | | and Tolan, J. W. and Muskal, | |
| | | S. M., Prediction of Human | |
| | | Intestinal Absorption of Drug | |
| | | Compounds From Molecular | |
| | | Structure, Journal of Chemical | |
| | | Information and Computer | |
| | | Sciences, 1998, 38: 726-735 | |
| | Length Over | Calculates the ratio of length to | LOBMAX, |
| | Breadth | breadth | LOBMIN |
| | Moment Of Inertia | Descriptor that calculates the | MOMI-X, MOMI- |
| | | principal moments of inertia | Y, MOMI-Z, |
| | | and ratios of the principal | MOMI-XY, MOMI- |
| | | moments. Als calculates the | XZ, MOMI-YZ, |
| | | radius of gyration | MOMI-R |
| | Petitjean Shape | The topological and geometric | topoShape, |
| | Index | shape indices described | geomShape |
| | | Petitjean and Bath et al. | |
| | | respectively. Both measure the | |
| | | anisotropy in a molecule | |
| Electrostatic | Ionizational | Descriptor that evaluates the | IonzPot |
| descriptor | Potential | ionization potential | |
| | Charged Partial | A variety of descriptors | PPSA-1, PPSA-2, |
| | Surface Area | combining surface area and | PPSA-3, PNSA-1, |
| | | partial charge information; | PNSA-2, PNSA- |
| | | Stanton, D. T. and Jurs, P. C., | 3, DPSA-1, |
| | | Development and Use of | DPSA-2, DPSA- |
| | | Charged Partial Surface Area | 3, FPSA-1, |
| | | Structural Descriptors in | FPSA-2, FPSA-3, |
| | | Computer Assissted | FNSA-1, FNSA-2, |
| | | Quantitative Structure Property | FNSA-3, WPSA- |
| | | Relationship Studies, | 1, WPSA-2, |
| | | Analytical Chemistry, 1990, | WPSA-3, WNSA- |
| | | 62: 2323-2329 | 1, WNSA-2, |
| | | | WNSA-3, RPCG, |
| | | | RNCG, RPCS, |
| | | | RNCS, THSA, |
| | | | TPSA, RHSA, |
| | | | RPSA |
| | BPol | Descriptor that calculates the | bpol |
| | | sum of the absolute value of | |
| | | the difference between atomic | |
| | | polarizabilities of all bonded | |
| | | atoms in the molecule | |
| | | (including implicit hydrogens) | |
| Topological | Carbon Connec | carbon connectivity index | chi0vC |
| descriptor | Order Zero | (order 0) | |
| | Carbon Connec | carbon connectivity index | chi1vC |
| | Order One | (order 1) | |
| | Chi Chain Indices | Evaluates the Kier & Hall Chi | SCH-3, SCH-4, |
| | | chain indices of orders 3, 4, 5 | SCH-5, SCH-6, |
| | | and 6; | SCH-7, VCH-3, |
| | | Kier, L. B., and Hall, L. H. | VCH-4, VCH-5, |
| | | (1976). Molecular connectivity | VCH-6, VCH-7 |
| | | in chemistry and drug | |
| | | research, (New York: | |
| | | Academic Press). | |
| | Chi Cluster | Evaluates the Kier & Hall Chi | SC-3, SC-4, SC- |
| | Indices | cluster indices of orders 3, 4, 5, 6 | 5, SC-6, VC-3, |
| | | and 7; | VC-4, VC-5, VC-6 |
| | | Kier, L. B., and Hall, L. H. | |
| | | (1976). Molecular connectivity | |
| | | in chemistry and drug | |
| | | research, (New York: | |
| | | Academic Press). | |
| | Chi path Indices | Evaluates the Kier & Hall Chi | SP-0, SP-1, SP- |
| | | path indices of orders | 2, SP-3, SP-4, |
| | | 0, 1, 2, 3, 4, 5, 6 and 7; | SP-5, SP-6, SP- |
| | | Kier, L. B., and Hall, L. H. | 7, VP-0, VP-1, |
| | | (1976). Molecular connectivity | VP-2, VP-3, VP- |
| | | in chemistry and drug | 4, VP-5, VP-6, |
| | | research, (New York: | VP-7 |
| | | Academic Press). | |
| | Chi path Cluster | Evaluates the Kier & Hall Chi | SPC-4, SPC-5, |
| | Indices | path cluster indices of orders | SPC-6, VPC-4, |
| | | 4, 5 and 6; | VPC-5, VPC-6 |
| | | Kier, L. B., and Hall, L. H. | |
| | | (1976). Molecular connectivity | |
| | | in chemistry and drug | |
| | | research, (New York: | |
| | | Academic Press). | |
| | Eccentric | A topological descriptor | ECCEN |
| | Connectivity | combining distance and | |
| | Index | adjacency information | |
| | Kappa Shape Indices | Descriptor that calculates Kier | Kier1, Kier2, |
| | | and Hall kappa molecular | Kier3 |
| | | shape indices; | |
| | | Hall, L. H., and Kier, L. B. | |
| | | (1991). The molecular | |
| | | connectivity chi indices and | |
| | | kappa shape indices in | |
| | | structure-property modeling. In | |
| | | Reviews of Computational | |
| | | Chemistry, K. B. Lipkowitz, and | |
| | | D. B. Boyd, eds. (New York: | |
| | | VCH publishers), pp. 367-412. | |
| | MDE | Evaluate molecular distance | MDEC-11, |
| | | edge descriptors for C, N and | MDEC-12, |
| | | O; | MDEC-13, |
| | | Liu, S. and Cao, C. and Li, Z. , | MDEC-14, |
| | | Approach to Estimation and | MDEC-22, |
| | | Prediction for Normal Boiling | MDEC-23, |
| | | Point (NBP) of Alkanes Based | MDEC-24, |
| | | on a Novel Molecular Distance | MDEC-33, |
| | | Edge (MDE) Vector, lambda, | MDEC-34, |
| | | Journal of Chemical | MDEC-44, |
| | | Information and Computer | MDEO-11, |
| | | Sciences, 1998, 38: 387-394 | MDEO-12, |
| | | | MDEO-22, |
| | | | MDEN-11, |
| | | | MDEN-12, |
| | | | MDEN-13, |
| | | | MDEN-22, |
| | | | MDEN-23, |
| | | | MDEN-33 |
| | Autocorrelation | Moreau-Broto autocorrelation | ATSp1, ATSp2, |
| | Polarizability | descriptors using polarizability; | ATSp3, ATSp4, |
| | | Moreau G. and Broto P., The | ATSp5 |
| | | autocorrelation of a topological | |
| | | structure: A new molecular | |
| | | descriptor, Nouveau Journal de | |
| | | Chimie, 1980, ?: 359-360 | |
| | Autocorrelation | Moreau-Broto autocorrelation | ATSc1, ATSc2, |
| | Charge | descriptors using partial | ATSc3, ATSc4, |
| | | charges; | ATSc5 |
| | | Moreau G. and Broto P., The | |
| | | autocorrelation of a topological | |
| | | structure: A new molecular | |
| | | descriptor, Nouveau Journal de | |
| | | Chimie, 1980, ?: 359-360 | |
| | Autocorrelation | Moreau-Broto autocorrelation | ATSm1, ATSm2, |
| | Mass | descriptors using atomic | ATSm3, ATSm4, |
| | | weight; | ATSm5 |
| | | Moreau G. and Broto P., The | |
| | | autocorrelation of a topological | |
| | | structure: A new molecular | |
| | | descriptor, Nouveau Journal de | |
| | | Chimie, 1980, ?: 359-360 | |
| | Petitjean Number | Descriptor that calculates the | PetitjeanNumber |
| | | Petitjean Number of a | |
| | | molecule | |
| | TPSA | Calculation of topological polar | TopoPSA |
| | | surface area based on | |
| | | fragment contributions; | |
| | | Ertl, P. and Rohde, B. and | |
| | | Selzer, P., Fast Calculation of | |
| | | Molecular Polar Surface Area | |
| | | as a Sum of Fragment-Based | |
| | | Contributions and Its | |
| | | Application to the Prediction of | |
| | | Drug Transport Properties, J. | |
| | | Med. Chem., 2000, 43: 3714- | |
| | | 3717 | |
| | Vertex Adj | Descriptor that calculates the | VAdjMat |
| | Magnitude | vertex adjacency information of | |
| | | a molecule | |
| | Weighted Path | The weighted path (molecular | WTPT-1, WTPT- |
| | | ID) descriptors described by | 2, WTPT-3, |
| | | Randic. They characterize | WTPT-4, WTPT-5 |
| | | molecular branching; | |
| | | Randic, M., On molecular | |
| | | identification numbers, Journal | |
| | | of Chemical Information and | |
| | | Computer Science, 1984, | |
| | | 24: 164-175 | |
| | Weinner Number | This class calculates Wiener | WPATH, WPOL |
| | | path number and Wiener | |
| | | polarity number; | |
| | | Wiener, Harry, Structural | |
| | | Determination of Paraffin | |
| | | Boiling Points, Journal of the | |
| | | American Chemical Society, | |
| | | 1947, 69: 17-20 | |
| | Zagreb Index | The sum of the squared atom | Zagreb |
| | | degrees of all heavy atoms | |
| | WHIM | Holistic descriptors described | Wlambda1.unity, |
| | | by Todeschini et al; | Wlambda2.unity, |
| | | Todeschini, R. and Gramatica, | Wlambda3.unity, |
| | | P., New 3D Molecular | Wnu1.unity, |
| | | Descriptors: The WHIM theory | Wnu2.unity, |
| | | and QAR Applications, | Wgamma1.unity, |
| | | Persepectives in Drug | Wgamma2.unity, |
| | | Discovery and Design, | Wgamma3.unity, |
| | | 1998, ?: 355-380 | Weta1.unity, |
| | | | Weta2.unity, |
| | | | Weta3.unity, |
| | | | WT.unity, |
| | | | WA.unity, |
| | | | WV.unity, |
| | | | WK.unity, |
| | | | WG.unity, |
| | | | WD.unity |
| | BCUT | Eigenvalue based descriptor | BCUTw-1l, |
| | | noted for its utility in chemical | BCUTw-1h, |
| | | diversity described by | BCUTc-1l, |
| | | Pearlman et al.; | BCUTc-1h, |
| | | Pearlman, R. S. and Smith, | BCUTp-1l, |
| | | K. M., Metric Validation and the | BCUTp-1h |
| | | Receptor-Relevant Subspace | |
| | | Concept, J. Chem. Inf. | |
| | | Comput. Sci., 1999, 39: 28-35; | |
| | | Burden, F. R., Molecular | |
| | | identification number for | |
| | | substructure searches, J. | |
| | | Chem. Inf. Comput. Sci., 1989, | |
| | | 29: 225-227; | |
| | | Burden, F. R., Chemically | |
| | | Intuitive Molecular Index, | |
| | | Quant. Struct.-Act. Relat., | |
| | | 1997, 16: 309-314; | |
| | | Kang, Y. K. and Jhon, M. S., | |
| | | Additivity of Atomic Static | |
| | | Polarizabilities and Dispersion | |
| | | Coefficients, Theoretica | |
| | | Chimica Acta, 1982, 61: 41-48 | |
| | Atomic valence | The sum of 1/sqrt(vi) over all | chi0v |
| | connectivity index | heavy atoms i with vi > 0 | |
| | (order 0) | | |
| | Atomic valence | The sum of 1/sqrt(vivj) over all | chi1v |
| | connectivity index | bonds between heavy atoms i | |
| | (order1) | and j where i < j | |
| | Fragment | Class that returns the | fragC |
| | Complexity | complexity of a system. The | |
| | | complexity is defined as | |
| | | @cdk.cite{Nilakantan06}; | |
| | | Nilakantan, R. and Nunn, D. S. | |
| | | and Greenblatt, L. and Walker, | |
| | | G. and Haraki, K. and Mobilio, | |
| | | D., A family of ring system- | |
| | | based structural fragments for | |
| | | use in structure-activity | |
| | | studies: database mining and | |
| | | recursive partitioning., Journal | |
| | | of chemical information and | |
| | | modeling, 2006, 46: 1069-1077 | |

Among the 172 calculated values, two principal components were selected based on a cumulative proportion of importance of 65% or higher after performing principal component analysis (PCA), and then, a toxicity prediction model was generated via a support vector machine (SVM), which is an artificial intelligence method (method 1). Meanwhile, 254 calculated values were obtained using only a topological descriptor for the 73 chemical substances, referring to the conventional Faulon's method (Biotechnology and Bioengineering, Vol. 109, No. 3, March, 2012). Twenty principal components were selected by performing PCA analysis based on a cumulative proportion of importance of 65% or higher, and a toxicity prediction model was generated via the SVM method for comparison with method 1 (method 2). R² values between the predicted value and the real value, regarding the IC₅₀ value predicted in the toxicity prediction model generated according to the method 1 and the IC₅₀ value according to method 2, were compared using a leave-one-out method. Leave-one-out involves using a single observation from the original sample as the validation data, and the remaining observations as the training data. This is repeated such that each observation in the sample is used once as the validation data. As shown in Table 2 below, the R² value of the method 1 was shown to be greater than that of the method 2 thus confirming that the prediction model of the present invention is more accurate than the prediction model of the conventional method.

TABLE 2

| Method | Method 1 | Method 2 |
|---|---|---|
| R² between predicted | 0.605 | 0.525 |
| value and real value | | |

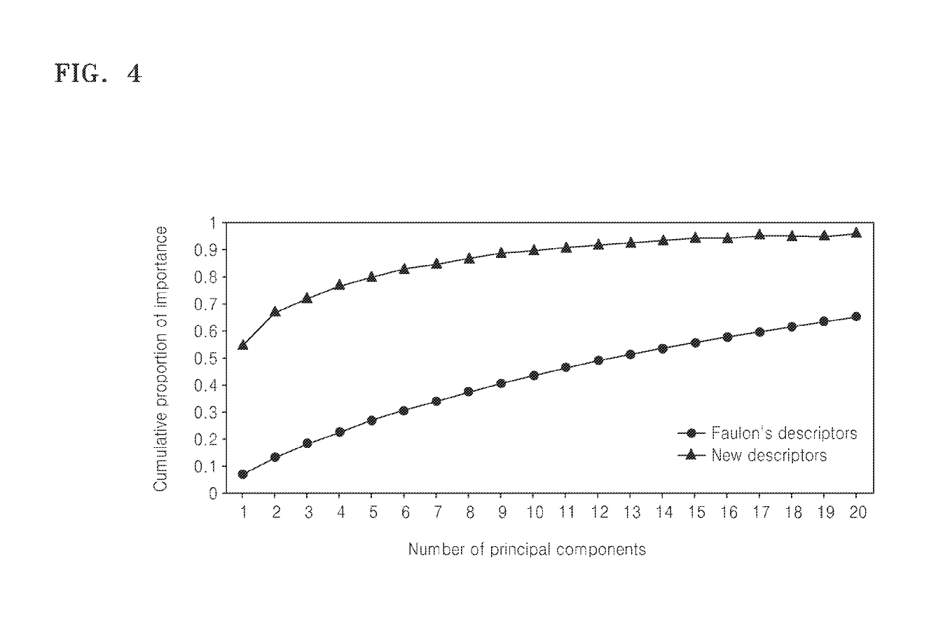

Furthermore, as shown in FIG. 4, the number of principal components necessary for the explanation of 65% of data in the method 2 was twenty while in the method 1 only two principal components were able to explain 65% of data. From this, it was confirmed that when a prediction model was generated using a molecular descriptor along with a topological molecular descriptor as in the present invention, as compared with a conventional prediction model generated based on a topological molecular descriptor alone, data explanation was possible with a fewer number of principal components.

### EXAMPLE 2

### Prediction of Toxicity of Chemical Substances within TCA Cycle

IC₅₀ values of intermediate metabolites in a TCA cycle were obtained by applying them in a toxicity prediction model. As shown in Table 3, the toxicity of the materials was not of significance. From this, it was confirmed that the prediction model may be useful in the prediction of toxicity.

TABLE 3

| Intermediate Metabolites in TCA | IC₅₀ |
|---|---|
| Glucose | 4.212 |
| Citrate | 4.006 |
| Aconitate | 5.072 |
| Isocitrate | 2.944 |
| α-ketoglutarate | 9.222 |
| Succinate | 11.43 |
| Fumarate | 10.33 |
| Malate | 9.176 |
| Oxaloacetate | 6.327 |

### EXAMPLE 3

### Prediction of Toxicity of Antibiotics and Natural Metabolites

IC₅₀ values of antibiotics and natural metabolites were obtained by applying them to a toxicity prediction model. As shown in Table 4, antibiotics were shown to have a considerable toxicity to microorganisms whereas natural metabolites were shown to have a relatively weak toxicity. From this, it was confirmed that the prediction model may be useful in the prediction of toxicity.

TABLE 4

| | Chemical Substances | IC₅₀ |
|---|---|---|
| Antibiotics | Ampicillin | 0.009 |
| | Chloramphenicol | 0.412 |
| | Erythromycin | 0.069 |
| | Gentamycin | 0.002 |
| | Penicillin | 0.047 |
| | Streptomycin | 0.026 |
| | Sulfisoxazol | 0.701 |
| | Tobramycin | 0.003 |
| Natural | Fructose | 5.680 |
| Metabolites | Glucose | 4.212 |
| | Glycerol | 6.521 |
| | Xylose | 9.244 |
| | Galactose | 4.212 |
| | Fumaric acid | 10.330 |
| | homoserine | 11.328 |
| | 1-threonine | 10.992 |
| | Malic acid | 9.176 |
| | Oxaloacetate | 6.327 |
| | Succinic acid | 11.429 |

### EXAMPLE 4

### Prediction of Toxicity of Chemical Substances in the Biodegradation Pathway of Xenobiotic Compounds

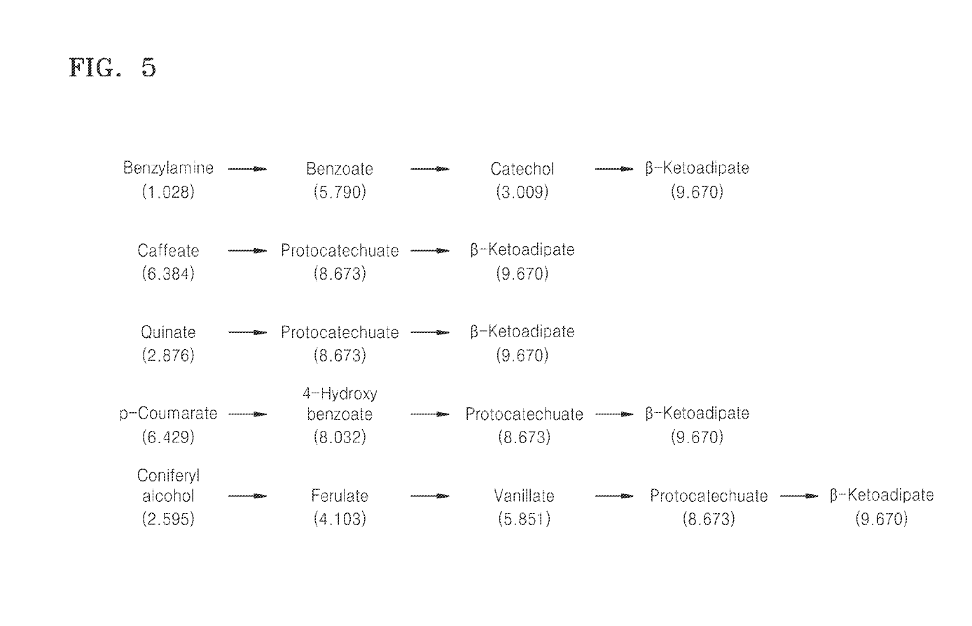

The toxicities of chemical substances in a biodegradation pathway of xenobiotic compounds, suggested in reference (Biotechnology Journal, 2010, 5(7):739-50), were predicted. FIG. 5 shows a result of predicted toxicity of chemical substances in the biodegradation pathway of xenobiotic compounds via a toxicity prediction model according to an embodiment of the present invention. The values within parentheses represent predicted IC₅₀ values. In each biodegradation pathway, the toxicity of compounds was gradually decreased as the biodegradation proceeded.

### EXAMPLE 5

### Prediction of Toxicity of Chemical Substances in a New Biosynthetic Pathway for 1,4-Butanediol

A suggested new biosynthetic pathway for 1,4-Butanediol (1,4-BDO) was re-evaluated using the toxicity values predicted via the toxicity prediction model. In the reference Nature Chemical Biology, 2011, 7(7): 445-52, the biosynthetic pathways were selected considering pathway distance, reactivity, theoretical yield of product, and chemical properties of intermediate metabolites. Of the pathways, only one pathway was found to be successful for the synthesis of 1,4-BDO.

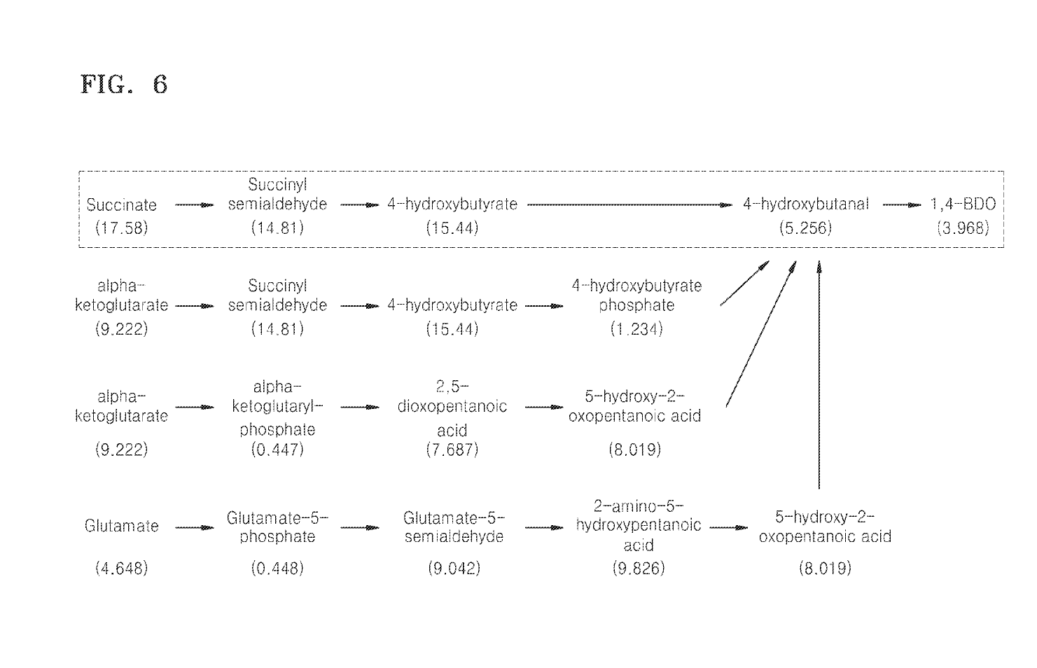

FIG. 6 shows a result of predicted toxicity of chemical substances in a new biosynthetic pathway of 1,4-BDO via a toxicity prediction model according to an embodiment of the present invention. The suggested new biosynthetic pathway was re-evaluated using the toxicity values obtained via the toxicity prediction model along with consideration of pathway distance, reactivity, theoretical yield of product, and chemical properties of intermediate metabolites. Priorities were given to the intermediate metabolites so that the higher the lowest IC₅₀ of an intermediate metabolite the better the priorities. As shown in FIG. 6, except the overlapping 4-hydroxybutanal and 1,4-BDO in the pathway, the lowest IC₅₀ values predicted were 14.81, 1.234, 0.447, and 0.448, respectively, thus the first pathway was ranked first. From this, it was confirmed that the success rate of biosynthesis can be increased by evaluating a new biosynthetic pathway using the toxicity prediction method along with the conventional four factors, which are pathway distance, reactivity, theoretical yield of product, and chemical properties of intermediate metabolites.

It should be understood that the exemplary embodiments described therein should be considered in a descriptive sense only and not for purposes of limitation. Descriptions of features or aspects within each embodiment should typically be considered as available for other similar features or aspects in other embodiments.

What is claimed is:

1. A computer-implemented method of generating a toxicity prediction model, the method comprising:
receiving information on toxicity to a microorganism, structural properties, and physicochemical properties of one or more chemical substances;
calculating molecular descriptors based on the information on structural properties and physicochemical properties;
selecting molecular descriptors based on the calculated molecular descriptors and the information on toxicity; and
generating a toxicity prediction model using the selected molecular descriptors to predict the toxicity of a chemical substance to the microorganism.

2. The method of claim 1, wherein the information on toxicity, structural properties, and physicochemical properties is received from a database or from a device that provides experimental data.

3. The method of claim 1, wherein the molecular descriptors comprise one or more of a constitutional descriptor, a physicochemical descriptor, a geometric descriptor, and an electrostatic descriptor.

4. The method of claim 3, wherein the molecular descriptors further comprise a topological descriptor.

5. A method of predicting toxicity of a chemical substance to a microorganism, the method comprising:
selecting a chemical substance;
applying the selected chemical substance to a toxicity prediction model generated according to the method of claim 1; and
predicting the toxicity of the chemical substance to the microorganism based on the toxicity prediction model.

6. The method of claim 1, wherein the information on toxicity includes quantitative information and/or qualitative information.

7. A method of assigning priorities to biosynthetic pathways for a target material, the method comprising:
receiving information for a plurality of biosynthetic pathways for a target material;
receiving information on the toxicity of intermediate metabolites in each of the biosynthetic pathways by applying the intermediate metabolites to a toxicity prediction model generated according to the method of claim 1, and evaluating toxicity of each biosynthetic pathway; and
assigning priorities to the biosynthetic pathways based on the toxicity evaluation.

8. The method of claim 7, wherein assigning priorities further comprises considering reaction properties and chemical properties of the intermediate metabolites.
